(19) United States
(12) Patent Application Publication
(10) Pub. No.: US 2025/0188629 A1
(43) Pub. Date: Jun. 12, 2025

(54) POWER CONTROL FOR HYDROGEN PRODUCTION

(71) Applicant: IHI Corporation, Tokyo (JP)

(72) Inventors: Akinobu INAMURA, Tokyo (JP); Hiroo TAKAHASHI, Tokyo (JP)

(21) Appl. No.: 19/058,013

(22) Filed: Feb. 20, 2025

Related U.S. Application Data
(63) Continuation of application No. PCT/JP2023/016883, filed on Apr. 28, 2023.

(30) Foreign Application Priority Data
Aug. 24, 2022 (JP) 2022-132991

(51) Int. Cl. C25B 9/65; C25B 1/04; C25B 15/02; H01M 10/44; H01M 10/46; H01M 16/00; H02J 3/32; H02J 3/38

(52) U.S. Cl. CPC C25B 9/65; C25B 1/04; C25B 15/02; H01M 10/44; H01M 10/465; H01M 16/00; H02J 3/32; H02J 3/38; H02J 2300/24

(57) ABSTRACT

A power control device for a hydrogen production system according to one aspect includes: a power generation device that generates electric power by using renewable energy; a hydrogen production device that produces hydrogen by using electric power generated by the power generation device; and a connector that connects the power generation device and the hydrogen production device to an electric power system. The power control device determines a power command value to be supplied to the hydrogen production device based on electric power generated by the power generation device and electric power that reversely flows to the electric power system so that hydrogen is produced in a state where a reverse power flow to the electric power system continuously occurs.

### CROSS-REFERENCE TO RELATED APPLICATIONS

This application is a continuation application of PCT Application No. PCT/JP2023/016883, filed Apr. 28, 2023, the entire contents of which are incorporated herein by reference.

### BACKGROUND

A water electrolyzer which produces hydrogen by electrolyzing water is utilized. In particular, hydrogen produced using only renewable energy without emitting carbon dioxide is called green hydrogen, and is expected to be widely used as an energy source with a small environmental burden. As a technique for producing hydrogen using a renewable energy source, a power generation system described in Japanese Unexamined Patent Publication No. 2017-51083 is known. The power generation system includes a solar panel, a storage battery, and a hydrogen production device for producing hydrogen using electric power generated by the solar panel, and produces hydrogen by supplying the hydrogen production device with surplus power which cannot be reversely supplied to a commercial system when the output is limited.

### SUMMARY

A power control device for a hydrogen production system according to one aspect of the present disclosure includes: a power generation device that generates electric power by using renewable energy; a hydrogen production device that produces hydrogen by using electric power generated by the power generation device; and a connector that connects the power generation device and the hydrogen production device to an electric power system. The power control device determines a power command value to be supplied to the hydrogen production device based on electric power generated by the power generation device and electric power that reversely flows to the electric power system so that hydrogen is produced in a state where a reverse power flow to the electric power system continuously occurs.

According to the aspects of the present disclosure, hydrogen that can be proved to be hydrogen derived from renewable energy can be produced.

### BRIEF DESCRIPTION OF DRAWINGS

FIG. 1 is a diagram schematically showing a hydrogen production system according to an example.

FIG. 2 is a block diagram showing a functional configuration of a power control device.

FIG. 3 is a block diagram showing an example of a hardware configuration of a power control device.

FIG. 4 is a flowchart showing a flow of processing of a power control device when a water electrolyzer is in a stopped state.

FIG. 5 is a flowchart showing a flow of processing of a power control device when a water electrolyzer is in an operating state.

### DETAILED DESCRIPTION

A power control device for a hydrogen production system according to one aspect of the present disclosure includes: a power generation device that generates electric power by using renewable energy; a hydrogen production device that produces hydrogen by using electric power generated by the power generation device; and a connector that connects the power generation device and the hydrogen production device to an electric power system. The power control device determines a power command value to be supplied to the hydrogen production device based on electric power generated by the power generation device and electric power that reversely flows to the electric power system so that hydrogen is produced in a state where a reverse power flow to the electric power system continuously occurs.

Since the power control device produces hydrogen in a state where electric power is continuously reversely flowed to the electric power system, the electric power received from the electric power system is prevented from being unintentionally used for the production of hydrogen. As a result, hydrogen that can be proved to be derived from renewable energy can be produced.

The power control device may determine the power command value Pav based on a following equation (1), where Ppv is electric power generated by the power generation device, Pax is standby power of the hydrogen production device, and Pex is electric power that reversely flows to the electric power system.

$$Pav = Ppv - Pax - Pex \qquad ( 1 )$$

The hydrogen production system may further includes a power storage device connected to the connector, may charge the power storage device with electric power generated by the power generation device without operating the hydrogen production device when the hydrogen production device is stopped and the power command value is smaller than a threshold value, and may output the power command value to the hydrogen production device to produce hydrogen when the power command value is equal to or larger than the threshold value. By operating the hydrogen production device to produce hydrogen after the power command value becomes equal to or larger than the threshold value, the hydrogen production device is less likely to stop due to fluctuations in the power generation amount of the power generation device, so that the operating rate of the hydrogen production device is improved. As a result, hydrogen production efficiency can be increased.

When the hydrogen production device is in operation and the power command value is smaller than the threshold value, the power command value may be output to the hydrogen production device to produce hydrogen, and an insufficient amount of electric power may be discharged from the power storage device. By discharging the insufficient amount of electric power from the power storage device, hydrogen can be continuously produced using the hydrogen production device even when the power generation amount of the power generation device is reduced. Therefore, the operating rate of the hydrogen production device can be improved, and the hydrogen production efficiency can be increased.

The power control device may stop the hydrogen production device when a remaining amount of electric power stored in the power storage device becomes equal to or smaller than a reference value due to a discharge of electric power from the power storage device. By stopping the hydrogen production device when the remaining amount of stored electric power becomes equal to or smaller than the reference value, the reverse power flow to the electric power system can be continued using the stored electric power.

When the power command value is larger than a rated power of the hydrogen production device, the power control device may operate the hydrogen production device at the rated power and charge the power storage device with surplus power. The energy efficiency of the hydrogen production system can be improved by storing the surplus power in the power storage device.

A hydrogen production system according to the present disclosure includes: a power generation device that generates electric power by using renewable energy; a hydrogen production device that produces hydrogen by using electric power generated by the power generation device; a connector that connects the power generation device and the hydrogen production device to an electric power system; and a power control device that controls an operation of the hydrogen production device. The power control device determines a power command value to be supplied to the hydrogen production device based on electric power generated by the power generation device and electric power that reversely flows to the electric power system so that hydrogen is produced in a state where a reverse power flow to the electric power system continuously occurs.

In the hydrogen production system, since hydrogen is produced in a state in which a reverse power flow to the electric power system continuously occurs, it is possible to prevent unintended electric power reception from the electric power system. As a result, hydrogen that can be proved to be derived from renewable energy can be produced.

The hydrogen production system may further include a power storage device connected to the connector, the power control device may charge the power storage device with electric power generated by the power generation device without operating the hydrogen production device when the hydrogen production device is stopped and the power command value is smaller than a threshold value, and the power control device may output the power command value to the hydrogen production device to produce hydrogen when the power command value is equal to or larger than the threshold value. By operating the hydrogen production device to produce hydrogen after the power command value becomes equal to or larger than the threshold value, the hydrogen production device is less likely to stop due to fluctuations in the power generation amount of the power generation device, so that the operating rate of the hydrogen production device is improved. As a result, hydrogen production efficiency can be increased.

When the hydrogen production device is in operation and the power command value is smaller than the threshold value, the power control device may output the power command value to the hydrogen production device to produce hydrogen, and may discharge an insufficient amount of electric power from the power storage device. By discharging the insufficient amount of electric power from the power storage device, hydrogen can be continuously produced even when the power generation amount of the power generation device is reduced. Therefore, the operating rate of the hydrogen production device can be improved, and the hydrogen production efficiency can be increased.

A hydrogen production method according to the present disclosure includes: acquiring a power generation amount of a power generation device that generates electric power by using renewable energy; reversely flowing at least a part of the electric power generated by the power generation device to an electric power system; determining a power command value to be supplied to a hydrogen production device based on the electric power generated by the power generation device and the electric power reversely flowed to the electric power system; and outputting the power command value to the hydrogen production device to produce hydrogen in a state where reverse power flow to the electric power system continuously occurs.

In the hydrogen production method, since hydrogen is produced in a state in which a reverse power flow to the electric power system continuously occurs, it is possible to prevent unintended electric power reception from the electric power system. As a result, hydrogen that can be proved to be derived from renewable energy can be produced.

Examples of the present disclosure will be described below with reference to the drawings. In the following description, the same or equivalent elements are denoted by the same reference numerals, and the redundant description will not be repeated.

### [Hydrogen Production System]

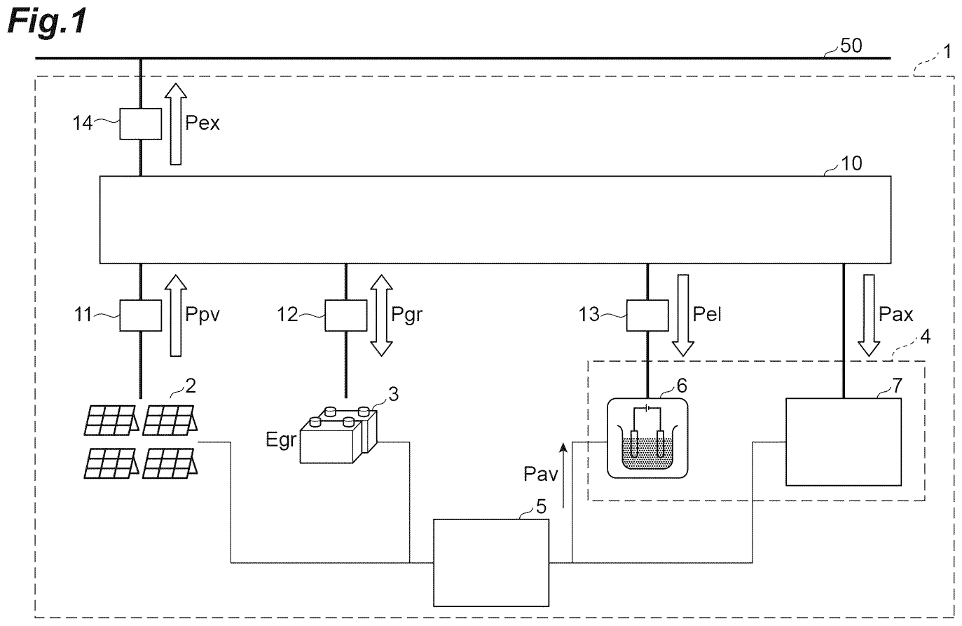

FIG. 1 is a diagram schematically showing a hydrogen production system 1 according to an example. The hydrogen production system 1 produces hydrogen derived from renewable energy. As shown in FIG. 1, the hydrogen production system 1 includes a power generation device 2, a power storage device 3, a hydrogen production device 4, a power control device 5, and a connector 10.

The connector 10 electrically connects the power generation device 2, the power storage device 3, and the hydrogen production device 4 to each other. The connector 10 is, for example, a distribution board for distributing electric power to various devices. The connector 10 is connected to an electric power system 50 which is an external general power transmission/distribution system, and transmits electric power to the electric power system 50 or receives electric power from the electric power system 50 in accordance with the supply power and power consumption of the hydrogen production system 1. The supply power of the hydrogen production system 1 is a total value of the electric power generated by the power generation device 2 and the electric power discharged from the power storage device 3. The power consumption of the hydrogen production system 1 is a total value of the power consumption of the hydrogen production device 4 (a total value of the power consumption of a water electrolyzer 6 and the power consumption of an auxiliary device 7, which will be described later) and the electric power charged in the power storage device 3.

For example, when the supply power of the hydrogen production system 1 is larger than the power consumption, the electric power flows out from the hydrogen production system 1 to the electric power system 50 through the connector 10. On the other hand, when the supply power of the hydrogen production system 1 is smaller than the power consumption, the electric power flows from the electric power system 50 into the hydrogen production system 1 through the connector 10. As will be described later, the hydrogen production system 1 produces hydrogen in a state in which a reverse power flow to the electric power system 50 continuously occurs. The reverse power flow refers to the transmission of electric power exceeding 0 kW from the hydrogen production system 1 to the electric power system 50. By connecting the connector 10 to the electric power system 50, the frequency of the electric power propagating through the connector 10 is synchronized with the frequency of the commercial power of the electric power system 50.

In one example, a relay device 14 (relay) may be provided between the connector 10 and the electric power system 50. The relay device 14 monitors the electric power flowing from the electric power system 50 to the hydrogen production system 1, and cuts off the forward power flow from the electric power system 50 to the hydrogen production system 1. The forward power flow means a flow of electric power flowing into the hydrogen production system 1 from the electric power system 50. By preventing the inflow of electric power from the electric power system 50, the electric power of the electric power system 50 including non-renewable energy is reliably prevented from being used for the production of hydrogen. When the relay device 14 operates, the operation of the hydrogen production system 1 is forcibly stopped. In order to prevent the forced stop, the hydrogen production system 1 prevents the inflow of electric power from the electric power system 50 to the hydrogen production system 1 regardless of the operation of the relay device 14.

The power generation device 2 is a renewable energy power generation device that generates electric power using renewable energy. For example, the power generation device 2 is a photovoltaic power generation facility including a solar panel for converting solar light (photovoltaic: PV) into electric power. The type of the power generation device 2 is not limited to the photovoltaic power generation as long as the renewable energy is used. For example, the power generation device 2 may be a device that generates electric power by wind power generation, geothermal power generation, or biomass power generation.

The power generation amount Ppv of the power generation device 2 using the renewable energy varies with time. For example, the power generation amount of photovoltaic power generation varies greatly depending on the solar radiation amount and the temperature. The power generation amount of wind power generation varies greatly depending on the wind speed. Similarly, in biomass power generation, there are cases where the properties of the raw material biomass are not constant, and in such cases, the output is not stable. When the power generation amount Ppv of the power generation device 2 varies, the hydrogen production system 1 according to one example adjusts the loads of the power storage device 3 and the hydrogen production device 4 (the power consumption of the hydrogen production system 1) to continuously generate a reverse power flow to the electric power system 50.

A power conversion device 11 is provided between the power generation device 2 and the connector 10. The power conversion device 11 is, for example, a power conditioner (power conditioning system: PCS) for converting direct current (DC) electric power generated by the power generation device 2 into alternating current (AC) electric power.

The power storage device 3 includes a storage battery for storing the electric power generated by the power generation device 2. The storage battery included in the power storage device 3 is, for example, a secondary battery such as a lithium ion battery, a lead-acid battery, or a redox flow battery. The power storage device 3 may be an energy storage device other than a secondary battery, such as a flywheel, a compressed air energy storage (CAES) facility, or a large-capacity capacitor, as long as it can convert electric power into some energy and store it. The power storage device 3 may further include a monitoring device for monitoring the remaining amount of the storage battery (remaining power storage amount) and a controller for controlling charging and discharging of the storage battery.

A power conversion device 12 is provided between the power storage device 3 and the connector 10. The power conversion device 12 is a power conditioner that converts DC electric power and AC electric power into each other. For example, when electric power is charged into the power storage device 3, the power conversion device 12 converts the AC electric power supplied from the connector 10 into DC electric power. On the other hand, when the electric power is discharged from the power storage device 3, the power conversion device 12 converts the DC electric power discharged from the power storage device 3 into AC electric power. In the following description, the electric power charged into and discharged from the power storage device 3 is referred to as Pgr. The positive electric power Pgr means the electric power supplied (discharged) from the power storage device 3, and the negative electric power Pgr means the electric power consumed by (charged into) the power storage device 3.

The hydrogen production device 4 produces hydrogen using the electric power generated by the power generation device 2. The hydrogen production device 4 includes the water electrolyzer 6 for producing hydrogen by electrolyzing water, and the auxiliary device 7 for operating the water electrolyzer 6. The amount of hydrogen produced by the water electrolyzer 6 depends on the power consumption of the water electrolyzer 6. Specifically, as the power consumption Pel of the water electrolyzer 6 increases, the production amount of hydrogen increases. The power consumption Pel of the water electrolyzer 6 is adjusted in accordance with the power command value Pav received from the power control device 5. The hydrogen production device 4 may include a storage device for storing the produced hydrogen.

The auxiliary device 7 is an accessory device for operating the water electrolyzer 6. Examples of the auxiliary device 7 include a cooling water pump for circulating cooling water, an electrolyte pump for circulating an electrolyte solution, an antifreezing heater, a chiller, and the like. In order to smoothly operate or stop the operation of the water electrolyzer 6, the auxiliary device 7 operates not only during the operation of the water electrolyzer 6 but also during the stop of the water electrolyzer 6. Therefore, the power consumption Pax of the auxiliary device 7 is substantially constant regardless of the operating state of the water electrolyzer 6. That is, it can be said that the power consumption Pax of the auxiliary device 7 is the standby power of the hydrogen production device 4.

A rectifier 13 is provided between the water electrolyzer 6 and the connector 10. The rectifier 13 converts the AC electric power from the connector 10 into DC electric power, and supplies the DC electric power to the water electrolyzer 6. The water electrolyzer 6 produces hydrogen using the DC electric power supplied from the rectifier 13. When the water electrolyzer 6 is operated by AC electric power, the rectifier 13 does not have to be provided.

### [Power Control Device]

The power control device 5 is a computer such as a programmable logic controller (PLC) including a processor, a storage device, an input device, a display device, a communication device and the like, and controls the operation of the entire hydrogen production system 1. The power control device 5, for example, loads a program stored in the storage device and executes the loaded program by the processor, thereby realizing various functions described later. In the power control device 5, the operator can input commands to manage the hydrogen production system 1 using the input device, and the operation status of the hydrogen production system 1 can be visualized and displayed by the display device.

The power control device 5 is communicably connected to the power generation device 2, the power storage device 3, the water electrolyzer 6, and the auxiliary device 7. The power control device 5 transmits control signals to the power storage device 3, the water electrolyzer 6, and the auxiliary device 7 to control the operations of the power storage device 3, the water electrolyzer 6, and the auxiliary device 7. More specifically, the power control device 5 controls the power consumption Pel of the water electrolyzer 6 and the electric power Pgr charged into and discharged from the power storage device 3 so that hydrogen is produced in a state in which a reverse power flow to the electric power system 50 continuously occurs. In other words, the supply power and the power consumption of the hydrogen production system 1 are adjusted based on the power generation amount Ppv of the power generation device 2 so that a constant reverse power flow Pex continuously flows out from the connector 10 to the electric power system 50. By producing hydrogen in a state in which a reverse power flow continuously occurs, hydrogen (green hydrogen) that can be proved to be produced using only renewable energy is produced.

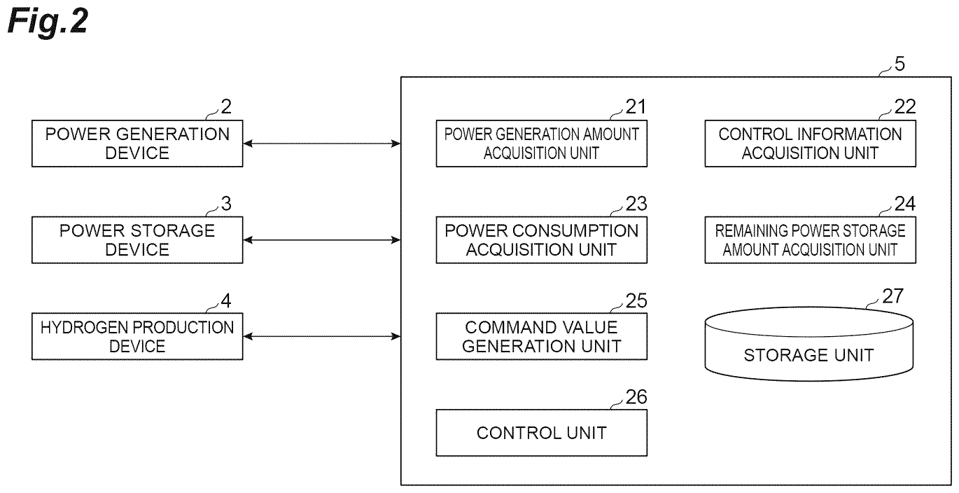

FIG. 2 is a block diagram showing the functional configuration of the power control device 5. As shown in FIG. 2, the power control device 5 includes, as a functional configuration, a power generation amount acquisition unit 21, a control information acquisition unit 22, a power consumption acquisition unit 23, a remaining power storage amount acquisition unit 24, a command value generation unit 25, a control unit 26, and a storage unit 27.

The power generation amount acquisition unit 21 acquires the power generation amount Ppv of the power generation device 2. For example, the power generation amount Ppv of the power generation device 2 is measured using a power meter provided in the power conversion device 11. The power generation amount acquisition unit 21 periodically acquires the measured value of the power generation amount Ppv of the power generation device 2.

The control information acquisition unit 22 acquires various kinds of information used for controlling the hydrogen production system 1. For example, the control information acquisition unit 22 acquires the power consumption Pax of the auxiliary device 7 and the minimum reverse power flow which is the minimum value of the electric power reversely flowing from the hydrogen production system 1 to the electric power system 50. The power consumption Pax of the auxiliary device 7 is a setting value determined by the specification of the auxiliary device 7. The minimum reverse power flow is a design value determined by a designer of the hydrogen production system 1. The minimum reverse 25 power flow is determined in consideration of a certain margin so that electric power does not flow in from the electric power system 50 unintentionally when the power generation amount Ppv of the power generation device 2 fluctuates.

The power consumption acquisition unit 23 periodically acquires the power consumption Pel of the water electrolyzer 6 included in the hydrogen production device 4. The remaining power storage amount acquisition unit 24 periodically acquires the remaining power storage amount Egr of the power storage device 3 (the amount of electric power stored in the power storage device 3). The remaining power storage amount Egr of the power storage device 3 is measured by, for example, a monitoring device of the power storage device 3. The power consumption acquisition unit 23 and the remaining power storage amount acquisition unit 24 store the acquired power consumption Pel and the acquired remaining power storage amount Egr in the storage unit 27 in time series, respectively.

The command value generation unit 25 generates a power command value Pav to be output to the water electrolyzer 6 based on the power generation amount Ppv of the power generation device 2, the power consumption Pax of the auxiliary device 7, and the reverse power flow Pex. The power command value Pav generated by the command value generation unit 25 is a target value of the power consumption Pel of the water electrolyzer 6. For example, the command value generation unit 25 determines the power command value Pav based on the following equation (1).

$$Pav = Ppv - Pax - Pex \qquad ( 1 )$$

In the equation (1), the reverse power flow Pex is set to the minimum reverse power flow. That is, the power command value Pav is the surplus power remaining after the power generation amount Ppv of the power generation device 2 is distributed to the power consumption Pax of the auxiliary device 7 and the reverse power flow Pex. In other words, by determining the power command value Pav based on the equation (1), it is possible to supply the electric power for producing hydrogen to the water electrolyzer 6 while continuously ensuring the electric power for reversely flowing to the electric power system 50.

The control unit 26 controls the water electrolyzer 6 to control the amount of hydrogen produced. For example, the control unit 26 transmits a control signal to the water electrolyzer 6 to switch between the operation and the stoppage of the water electrolyzer 6. When operating the water electrolyzer 6, the control unit 26 outputs the power command value Pav to the water electrolyzer 6 to cause the water electrolyzer 6 to produce hydrogen in accordance with the power command value Pav. Upon receiving the power command value Pav from the control unit 26, the water electrolyzer 6 adjusts the amount of hydrogen to be produced so that the power consumption Pel of the water electrolyzer 6 approaches the power command value Pav. That is, as the power command value Pav output from the control unit 26 to the water electrolyzer 6 increases, the amount of hydrogen produced by the water electrolyzer 6 increases.

The control unit 26 controls charging and discharging of the power storage device 3. For example, when a charge command value is transmitted from the control unit 26 to the power storage device 3, the power storage device 3 receives a part of the electric power generated by the power generation device 2 through the connector 10 and charges the storage battery with the part. On the other hand, when a discharge command value is transmitted from the control unit 26 to the power storage device 3, the power storage device 3 discharges the electric power stored in the storage battery toward the connector 10. The electric power Pgr discharged from the power storage device 3 is allocated to at least one of the power consumption Pel of the water electrolyzer 6, the power consumption Pax of the auxiliary device 7, and the reverse power flow Pex to the electric power system 50.

The storage unit 27 stores time-series data of various kinds of information such as the power generation amount Ppv of the power generation device 2, the electric power Pgr charged into and discharged from the power storage device 3, the remaining power storage amount Egr of the power storage device 3, the power command value Pav, and the power consumption Pel of the water electrolyzer 6. The storage unit 27 may store the power consumption Pax of the auxiliary device 7 and the minimum reverse power flow.

### [Hardware Configuration]

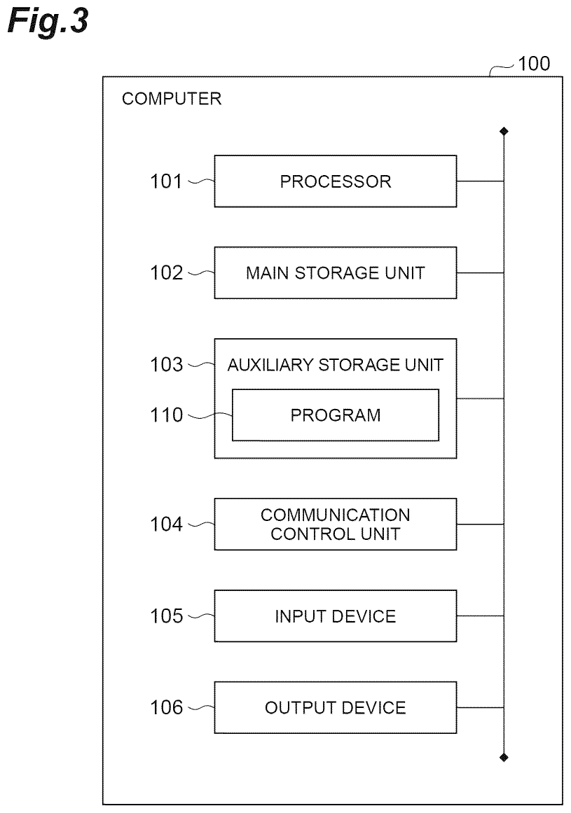

Next, the hardware configuration of the power control device 5 will be described. FIG. 3 is a block diagram showing an example of the hardware configuration of the power control device 5. As shown in FIG. 3, the power control device 5 includes one or more computers 100. The computer 100 includes a processor 101, a main storage unit 102, an auxiliary storage unit 103, a communication control unit 104, an input device 105, and an output device 106. The power control device 5 is constituted by one or more computers 100, which include the aforementioned hardware and software such as programs.

In the case where the power control device 5 is constituted by a plurality of computers 100, the plurality of computers 100 may be locally connected or connected through a communication network such as the Internet or an intranet. By this connection, one power control device 5 is logically constructed.

The processor 101 executes an operating system, an application program, and the like. The main storage unit 102 is constituted by a read only memory (ROM) and a random access memory (RAM). The auxiliary storage unit 103 is a storage medium constituted by a hard disk, a flash memory, and the like. The auxiliary storage unit 103 generally stores a larger amount of data than the main storage unit 102. The communication control unit 104 is constituted by a network card or a wireless communication module. At least part of the communication function with other devices in the power control device 5 may be realized by the communication control unit 104. The input device 105 includes a keyboard, a mouse, a touch panel, a microphone for voice input, and the like. The output device 106 includes a display, a printer, and the like.

The auxiliary storage unit 103 stores a program 110 and the data necessary for processing. The program 110 causes the computer 100 to execute each functional element of the power control device 5. By the program 110, for example, the function of the power control device 5 is realized in the computer 100. For example, the program 110 is read by the processor 101 or the main storage unit 102, and operates at least one of the processor 101, the main storage unit 102, the auxiliary storage unit 103, the communication control unit 104, the input device 105, and the output device 106. For example, the program 110 reads and writes the data in the main storage unit 102 and the auxiliary storage unit 103.

The program 110 may be provided recorded on a tangible storage medium such as a CD-ROM, a DVD-ROM, or a semiconductor memory. The program 110 may be provided as a data signal via a communication network.

### [Hydrogen Production Method]

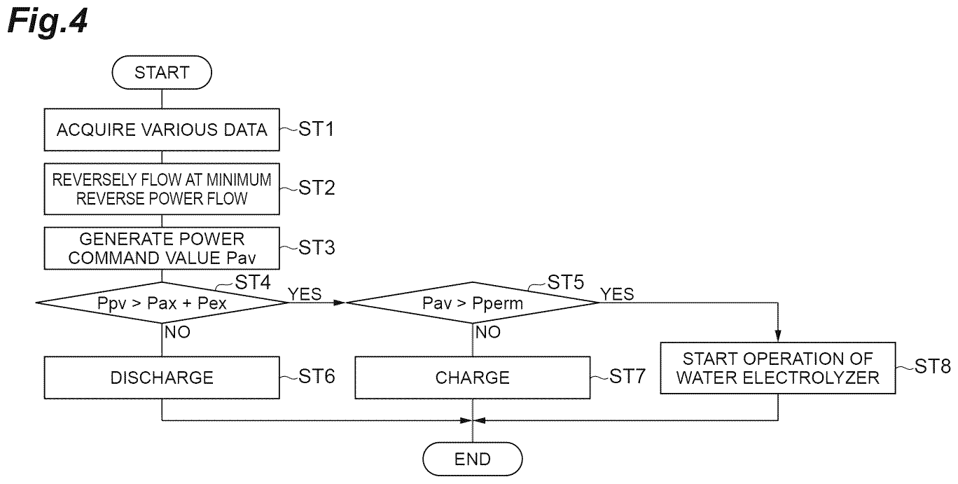

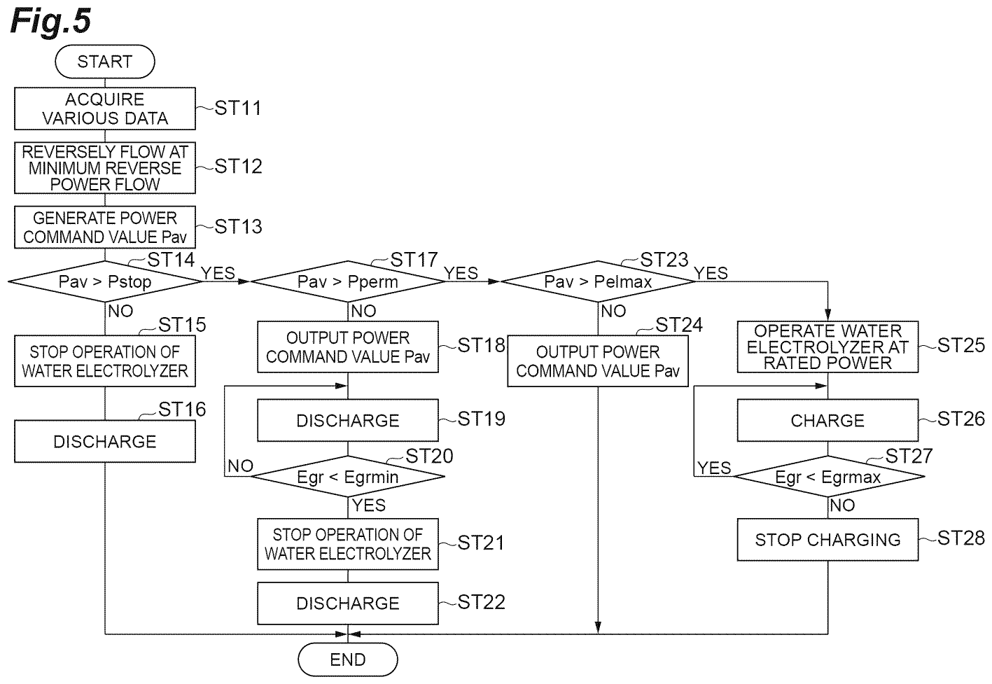

Next, the hydrogen production method according to one example will be described with reference to FIGS. 4 and 5. The hydrogen production method is executed by the power control device 5. More specifically, in order to prove that the hydrogen is derived from renewable energy, the power control device 5 produces hydrogen in a state in which the reverse power flow to the electric power system 50 continuously occurs by adjusting the load (power consumption) of the power storage device 3 and the hydrogen production device 4.

The operation of the power control device 5 varies depending on the operating state of the water electrolyzer 6. Therefore, in the following description, the operation of the power control device 5 will be described separately for the case where the water electrolyzer 6 is stopped and the case where the water electrolyzer 6 is in operation.

FIG. 4 is a flowchart showing the processing flow of the power control device 5 when the water electrolyzer 6 is stopped. Each step shown in FIG. 4 is repeatedly executed at a predetermined cycle. As shown in FIG. 4, in the hydrogen production method according to one example, first, the power generation amount acquisition unit 21, the control information acquisition unit 22, the power consumption acquisition unit 23, and the remaining power storage amount acquisition unit 24 of the power control device 5 acquire various data (step ST1). For example, the power generation amount Ppv of the power generation device 2, the power consumption Pax of the auxiliary device 7, the minimum reverse power flow, and the remaining power storage amount Egr of the power storage device 3 are acquired as various data. The acquired various data are stored in the storage unit 27.

Next, the electric power is reversely flowed to the electric power system 50 at the minimum reverse power flow (step ST2). That is, the reverse power flow Pex is set to the minimum reverse power flow. The reverse power flow Pex is allocated from the electric power generated by the power generation device 2 or the electric power discharged from the power storage device 3. Next, the command value generation unit 25 of the power control device 5 generates the power command value Pav (step ST3). The power command value Pav is determined based on the above equation (1).

Next, it is determined whether or not the power generation amount Ppv of the power generation device 2 is larger than the sum of the power consumption Pax of the auxiliary device 7 and the reverse power flow Pex (step ST4). When Ppv>Pax+Pex is not true, the power generation amount Ppv of the power generation device 2 cannot cover the power consumption Pax of the auxiliary device 7 and the reverse power flow Pex. Therefore, the control unit 26 controls the power storage device 3 to discharge the insufficient amount of electric power from the power storage device 3 (step ST6). At this time, the electric power Pgr discharged from the power storage device 3 is expressed by the following equation (2). The reverse power flow from the hydrogen production system 1 to the electric power system 50 is continued by the electric power Pgr discharged from the power storage device 3.

$$Pgr = Pax + Pex - Ppv \qquad ( 2 )$$

On the other hand, when Ppv>Pax+Pex is true, it is determined whether or not the power command value Pav is larger than a threshold value Pperm (step ST5). The threshold value Pperm is a value obtained by adding a certain margin to the sum of the minimum output of the water electrolyzer 6 and the power consumption Pax of the auxiliary device 7. The margin is set to a relatively large value so that the operation of the water electrolyzer 6 can be continued even if the power generation amount Ppv of the power generation device 2 decreases due to a change in weather or the like after the operation of the water electrolyzer 6 is started.

When the power command value Pav is equal to or smaller than the threshold value Pperm, the control unit 26 causes the power storage device 3 to be charged by using the surplus power without operating the water electrolyzer 6 (step ST7). This is because, if the operation of the water electrolyzer 6 is started in a state where the surplus power is insufficient, it would be necessary to stop the operation of the water electrolyzer 6 when the power generation amount Ppv of the power generation device 2 subsequently decreases, which would likely result in a lower operating rate of the water electrolyzer 6. In step ST7, the electric power Pgr to be charged to the power storage device 3 is set to the power command value Pav.

On the other hand, when the power command value Pav is larger than the threshold value Pperm, the operation of the water electrolyzer 6 is started (step ST8). The production of hydrogen is started by the operation of the water electrolyzer 6. Even in this case, a part of the power generation amount Ppv of the power generation device 2 is allocated to the reverse power flow Pex, and the reverse power flow to the electric power system 50 is continued.

Next, the operation of the power control device 5 after the operation of the water electrolyzer 6 will be described. FIG. 5 is a flowchart showing the flow of processing of the power control device 5 when the water electrolyzer 6 is in operation. Each step shown in FIG. 5 is repeatedly executed at a predetermined cycle.

As shown in FIG. 5, in the hydrogen production method according to one example, first, various data used for power control are acquired by the power control device 5 (step ST11). For example, the power generation amount Ppv of the power generation device 2, the power consumption Pax of the auxiliary device 7, the minimum reverse power flow, and the remaining power storage amount Egr of the power storage device 3 are acquired as various data. The acquired various data are stored in the storage unit 27.

Next, the electric power is reversely flowed to the electric power system 50 at the minimum reverse power flow (step ST12). That is, the reverse power flow Pex is set to the minimum reverse power flow. The reverse power flow Pex is allocated from the electric power generated by the power generation device 2 or the electric power discharged from the power storage device 3. Next, the command value generation unit 25 of the power control device 5 generates the power command value Pav (step ST13). The power command value Pav is determined based on the above equation (1).

Next, it is determined whether or not the power command value Pav is larger than the threshold value Pstop (step ST14). For example, the threshold value Pstop is a power threshold value at which the hydrogen production efficiency of the water electrolyzer 6 is significantly reduced, and is smaller than the threshold value Pperm.

When the power command value Pav is equal to or smaller than the threshold value Pstop, the operation of the water electrolyzer 6 is stopped (step ST15). This is because, when the power command value Pav is smaller than the threshold value Pstop, stopping the water electrolyzer 6 rather than continuing the operation of the water electrolyzer 6 at a reduced output results in an increase in the total hydrogen production amount. Next, in order to cover the power consumption Pax of the auxiliary device 7 and the reverse power flow Pex, the insufficient amount of electric power is discharged from the power storage device 3 (step ST16). At this time, the electric power Pgr discharged from the power storage device 3 is expressed by the above equation (2). The reverse power flow from the hydrogen production system 1 to the electric power system 50 is continued by the electric power Pgr discharged from the power storage device 3.

On the other hand, when the power command value Pav is larger than the threshold value Pstop, it is determined whether or not the power command value Pav is larger than the threshold value Pperm (step ST17). When the power command value Pav is equal to or smaller than the threshold value Pperm, the control unit 26 outputs the power command value Pav to the water electrolyzer 6 (step ST18). As a result, the water electrolyzer 6 is operated at the power consumption Pel corresponding to the power command value Pav to produce hydrogen.

Here, when the power command value Pav is equal to or smaller than the threshold value Pperm, the power consumption Pel of the water electrolyzer 6, the power consumption Pax of the auxiliary device 7, and the reverse power flow Pex may not be covered by the power generation amount Ppv of the power generation device 2. In this case, the control unit 26 discharges the insufficient amount of electric power from the power storage device 3 (step ST19). At this time, the electric power Pgr discharged from the power storage device 3 is expressed by the following equation (3). That is, the power generation amount Ppv of the power generation device 2 and the electric power Pgr discharged from the power storage device 3 are allocated to the power consumption Pel of the water electrolyzer 6, the power consumption Pax of the auxiliary device 7, and the reverse power flow Pex.

$$Pgr = Pel + Pax + Pex - Ppv \qquad ( 3 )$$

Next, it is determined whether or not the remaining power storage amount Egr is smaller than a reference value Egrmin (step ST20). The reference value Egrmin is a power amount which can cover the power consumption Pax of the auxiliary device 7 and the reverse power flow Pex until the start of power generation by the power generation device 2 on the next day. The reference value Egrmin is determined based on, for example, the power consumption Pax, the minimum reverse power flow, and the current time. The reference value Egrmin may be adjusted by reducing the power consumption Pel of the water electrolyzer 6.

When the remaining power storage amount Egr is equal to or larger than the reference value Egrmin, the discharge from the power storage device 3 is continued (step ST19), and the operation of the water electrolyzer 6 is continued. On the other hand, when the remaining power storage amount Egr is smaller than the reference value Egrmin, the operation of the water electrolyzer 6 is stopped (step ST21). This is because when the remaining power storage amount Egr becomes smaller than the reference value Egrmin, the reverse power flow to the electric power system 50 cannot be continued until the time when the power generation device 2 starts power generation on the next day. After the operation of the water electrolyzer 6 is stopped, the insufficient amount of electric power is discharged from the power storage device 3 (step ST22). At this time, the electric power Pgr discharged from the power storage device 3 is expressed by the above equation (2). The reverse power flow from the hydrogen production system 1 to the electric power system 50 is continued by the electric power Pgr discharged from the power storage device 3.

On the other hand, when it is determined in step ST17 that the power command value Pav is larger than the threshold value Pperm, it is determined whether or not the power command value Pav is larger than a rated power Pelmax of the water electrolyzer 6 (step ST23). The rated power Pelmax is the maximum power of the water electrolyzer 6. When the power command value Pav is equal to or smaller than the rated power Pelmax of the water electrolyzer 6, the power command value Pav is output to the water electrolyzer 6 (step ST24). As a result, the water electrolyzer 6 produces hydrogen at an output corresponding to the power command value Pav.

On the other hand, when the power command value Pav is larger than the rated power Pelmax of the water electrolyzer 6, the water electrolyzer 6 is operated at the rated power Pelmax (step ST25). In this case, since surplus power is generated even if the water electrolyzer 6 is operated at the rated power Pelmax, the power storage device 3 is charged with the surplus power (step ST26). At this time, the electric power Pgr charged in the power storage device 3 is expressed by the following equation (4).

$$Pgr = Pelmax + Pax + Pex - Ppv \qquad ( 4 )$$

The charging of the power storage device 3 is continued until the remaining power storage amount Egr reaches the maximum remaining power storage amount Egrmax (step ST27). When the remaining power storage amount Egr reaches the maximum remaining power storage amount Egrmax, the charging of the power storage device 3 is stopped in order to protect the power storage device 3 (step ST28). When the surplus power is generated even after the charging of the power storage device 3 is stopped, the reverse power flow Pex is increased, and the surplus power reversely flows to the electric power system 50.

As described above, the power control device 5 adjusts the electric power Pgr charged into and discharged from the power storage device 3 and the power consumption Pel of the water electrolyzer 6 in accordance with the power generation amount Ppv of the power generation device 2 so that the reverse power flow continuously occurs from the hydrogen production system 1 to the electric power system 50. In this way, by producing hydrogen in a state where electric power is continuously reversely flowed to the electric power system 50, hydrogen can be produced by the water electrolyzer 6 without receiving electric power from the electric power system 50. The hydrogen produced in this way is green hydrogen that can be proved to be derived from renewable energy.

It is to be understood that not all aspects, advantages and features described herein may necessarily be achieved by, or included in, any one particular example. Indeed, having described and illustrated various examples herein, it should be apparent that other examples may be modified in arrangement and detail.

For example, as long as the renewable energy is used, the power generation device 2 may be a renewable energy power generation facility other than the photovoltaic power generation device. The power generation device 2 may be configured by combining a plurality of units and a plurality of types of renewable energy power generation facilities. Even in this case, hydrogen that can be proved to be derived from renewable energy can be produced by adjusting the loads of the power storage device 3 and the hydrogen production device 4 in accordance with the amount of electric power generated by the power generation device 2.

In the above-described examples, the hydrogen production system 1 includes the power storage device 3, but the power storage device 3 is not essential. Hydrogen may be produced in a state in which a reverse power flow to the electric power system 50 continuously occurs by adjusting the power consumption Pel of the water electrolyzer 6 in accordance with the amount of electric power generated by the power generation device 2.

In the above-described examples, although the electric power reversely flows to the electric power system 50 even when the operation of the water electrolyzer 6 is stopped, a reverse power flow to the electric power system 50 may continuously occurs at least during the operation of the water electrolyzer 6. As long as the reverse power flow continuously occurs during the operation of the water electrolyzer 6, the electric power from the electric power system 50 is prevented from being used for the production of hydrogen, so that hydrogen that can be proved to be derived from renewable energy can be produced.

The auxiliary device 7 of the hydrogen production device 4 may be stopped while the water electrolyzer 6 is stopped. In this case, the power command value Pav is determined based on the power generation amount Ppv of the power generation device 2 and the reverse power flow Pex.

### [Additional Statements]

The present disclosure contributes to the popularization of renewable energy in order to solve the problem of grid connection caused by unstable power generation of renewable energy. As such, the present disclosure also contributes to the following targets of the United Nations-led Sustainable Development Goals (SDGs):
Target 7.2 “By 2030, increase substantially the share of renewable energy in the global energy mix.”
Target 9.4 “By 2030, upgrade infrastructure and retrofit industries to make them sustainable, with increased resource-use efficiency and greater adoption of clean and environmentally sound technologies and industrial processes, with all countries taking action in accordance with their respective capabilities.”

### Additional Examples

It should be noted that the examples disclosed herein may include any combination of the following features, even in the absence of specific enumeration.

Example 1. A power control device for a hydrogen production system, the hydrogen production system comprising:
a power generation device configured to generate electric power by using renewable energy;
a hydrogen production device configured to produce hydrogen by using electric power generated by the power generation device; and
a connector configured to connect the power generation device and the hydrogen production device to an electric power system,
wherein the power control device determines a power command value to be supplied to the hydrogen production device based on electric power generated by the power generation device and electric power that reversely flows to the electric power system so that hydrogen is produced in a state where a reverse power flow to the electric power system continuously occurs.

Example 2. The power control device according to Example 1,
wherein the power command value Pav is determined based on a following equation (1), where Ppv is electric power generated by the power generation device, Pax is standby power of the hydrogen production device, and Pex is electric power that reversely flows to the electric power system.

$$Pav = Ppv - Pax - Pex \qquad ( 1 )$$

Example 3. The power control device according to Example 1 or 2,
wherein the hydrogen production system further comprises a power storage device connected to the connector,
wherein the power control device charges the power storage device with electric power generated by the power generation device without operating the hydrogen production device when the hydrogen production device is stopped and the power command value is smaller than a threshold value, and
wherein the power control device outputs the power command value to the hydrogen production device to produce hydrogen when the power command value is equal to or larger than the threshold value.

Example 4. The power control device according to Example 3,
wherein when the hydrogen production device is in operation and the power command value is smaller than the threshold value, the power control device outputs the power command value to the hydrogen production device to produce hydrogen, and discharges an insufficient amount of electric power from the power storage device.

Example 5. The power control device according to Example 3 or 4,
wherein the power control device stops the hydrogen production device when a remaining amount of electric power stored in the power storage device becomes equal to or smaller than a reference value due to a discharge of electric power from the power storage device.

Example 6. The power control device according to any one of Examples 3 to 5,
wherein when the power command value is larger than a rated power of the hydrogen production device, the power control device operates the hydrogen production device at the rated power and charges the power storage device with surplus power.

Example 7. A hydrogen production system comprising:
a power generation device configured to generate electric power by using renewable energy;
a hydrogen production device configured to produce hydrogen by using electric power generated by the power generation device;
a connector configured to connect the power generation device and the hydrogen production device to an electric power system; and
a power control device configured to control an operation of the hydrogen production device,
wherein the power control device determines a power command value to be supplied to the hydrogen production device based on electric power generated by the power generation device and electric power that reversely flows to the electric power system so that hydrogen is produced in a state where a reverse power flow to the electric power system continuously occurs.

Example 8. The hydrogen production system according to Example 7, further comprising a power storage device connected to the connector,
wherein the power control device charges the power storage device with electric power generated by the power generation device without operating the hydrogen production device when the hydrogen production device is stopped and the power command value is smaller than a threshold value, and
wherein the power control device outputs the power command value to the hydrogen production device to produce hydrogen when the power command value is equal to or larger than the threshold value.

Example 9. The hydrogen production system according to Example 8,
wherein when the hydrogen production device is in operation and the power command value is smaller than the threshold value, the power control device outputs the power command value to the hydrogen production device to produce hydrogen, and discharges an insufficient amount of electric power from the power storage device.

Example 10. A hydrogen production method comprising:
acquiring a power generation amount of a power generation device configured to generate electric power by using renewable energy;
reversely flowing at least a part of the electric power generated by the power generation device to an electric power system;
determining a power command value to be supplied to a hydrogen production device based on the electric power generated by the power generation device and the electric power reversely flowed to the electric power system; and
outputting the power command value to the hydrogen production device to produce hydrogen in a state where reverse power flow to the electric power system continuously occurs.

1. A power control device for a hydrogen production system, the hydrogen production system comprising:
a power generation device configured to generate electric power by using renewable energy;
a hydrogen production device configured to produce hydrogen by using the electric power generated by the power generation device; and
a connector configured to connect the power generation device and the hydrogen production device to an electric power system,
wherein the power control device determines a power command value to be supplied to the hydrogen production device based on the electric power generated by the power generation device and reverse electric power that flows to the electric power system so that the hydrogen is produced in a state where the reverse electric power continuously flows to the electric power system.

2. The power control device according to claim 1, wherein the power command value Pav is determined based on a following equation:
$$Pav = Ppv - Pax - Pex$$
where Ppv is the electric power generated by the power generation device, Pax is a standby power of the hydrogen production device, and Pex is the reverse electric power that flows to the electric power system.

3. The power control device according to claim 1, wherein the hydrogen production system further comprises a power storage device connected to the connector,
wherein the power control device charges the power storage device with the electric power generated by the power generation device without operating the hydrogen production device when the hydrogen production device is stopped and the power command value is smaller than a threshold value, and
wherein the power control device outputs the power command value to the hydrogen production device to produce the hydrogen when the power command value is equal to or larger than the threshold value.

4. The power control device according to claim 3, wherein when the hydrogen production device is in operation and the power command value is smaller than the threshold value, the power control device outputs the power command value to the hydrogen production device to produce the hydrogen, and discharges an insufficient amount of electric power from the power storage device.

5. The power control device according to claim 4, wherein the power control device stops the hydrogen production device when a remaining amount of electric power stored in the power storage device becomes equal to or smaller than a reference value due to a discharge of the insufficient amount of electric power from the power storage device.

6. The power control device according to claim 3, wherein when the power command value is larger than a rated power of the hydrogen production device, the power control device operates the hydrogen production device at the rated power and charges the power storage device with surplus power.

7. A hydrogen production system comprising:
a power generation device configured to generate electric power by using renewable energy;
a hydrogen production device configured to produce hydrogen by using the electric power generated by the power generation device;
a connector configured to connect the power generation device and the hydrogen production device to an electric power system; and
a power control device configured to control an operation of the hydrogen production device,
wherein the power control device determines a power command value to be supplied to the hydrogen production device based on the electric power generated by the power generation device and reverse electric power that flows to the electric power system so that hydrogen is produced in a state where the reverse electric power continuously flows to the electric power system.

8. The hydrogen production system according to claim 7, further comprising a power storage device connected to the connector,
wherein the power control device charges the power storage device with the electric power generated by the power generation device without operating the hydrogen production device when the hydrogen production device is stopped and the power command value is smaller than a threshold value, and
wherein the power control device outputs the power command value to the hydrogen production device to produce the hydrogen when the power command value is equal to or larger than the threshold value.

9. The hydrogen production system according to claim 8, wherein when the hydrogen production device is in operation and the power command value is smaller than the threshold value, the power control device outputs the power command value to the hydrogen production device to produce the hydrogen, and discharges an insufficient amount of the electric power from the power storage device.

10. The hydrogen production system according to claim 7, further comprising a relay provided between the connector and the electric power system, the relay configured to cut off forward power flow from the electric power system to the hydrogen production system,
wherein the hydrogen production device is forcibly stopped when the relay operates.

11. The hydrogen production system according to claim 7, wherein the hydrogen production device comprises:
a water electrolyzer configured to produce the hydrogen by electrolyzing water; and
an auxiliary device configured to operate the water electrolyzer.

12. The hydrogen production system according to claim 11, further comprising a power storage device connected to the connector,
wherein when the hydrogen production device is stopped and an amount of the electric power generated by the power generation device is equal to or smaller than a sum of power consumption of the auxiliary device and the reverse electric power, the power control device discharges an insufficient amount of the electric power from the power storage device so that the reverse electric power continues to flow.

13. The hydrogen production system according to claim 12, wherein when the hydrogen production device is stopped, the amount of the electric power generated by the generation device is larger than the sum of power consumption of the auxiliary device and the reverse electric power, and the power command value is equal to or smaller than a threshold value, the power control device charges the power storage device with surplus power without operating the water electrolyzer.

14. The hydrogen production system according to claim 12, wherein when the hydrogen production device is stopped, the amount of the electric power generated by the generation device is larger than the sum of power consumption of the auxiliary device and the reverse electric power, and the power command value is larger than a threshold value, the power control device operates the water electrolyzer to produce the hydrogen.

15. The hydrogen production system according to claim 11, further comprising a power storage device connected to the connector,
wherein when the hydrogen production device is in operation and the power command value is equal to or smaller than a threshold value at which a hydrogen production efficiency of the water electrolyzer is significantly reduced, the power control device stops the water electrolyzer and discharges an insufficient amount of the electric power from the power storage device which is equal to or greater than a sum of power consumption of the auxiliary device and the reverse electric power.

16. The hydrogen production system according to claim 15,
wherein the threshold value is a first threshold value, and
wherein when the hydrogen production device is in operation and the power command value is larger than the first threshold value and is equal to or smaller than a second threshold value which is larger than the first threshold value, the power control device outputs the power command value to the water electrolyzer to produce the hydrogen.

17. The hydrogen production system according to claim 16, wherein the power control device discharges the insufficient amount of electric power from the power storage device which is equal to or greater than a sum of power consumption of the water electrolyzer, the power consumption of the auxiliary device, and the reverse electric power.

18. The hydrogen production system according to claim 17, wherein the power control device stops the water electrolyzer when a remaining amount of electric power stored in the power storage device becomes equal to or smaller than a reference value due to a discharge of the electric power from the power storage device.

19. The hydrogen production system according to claim 18, wherein the reference value is a power amount which is equal to or greater than the sum of the power consumption of the auxiliary device and the reverse electric power until the power generation device starts generating the electric power within 24 hours.

20. A hydrogen production method comprising:
acquiring an amount of electric power from a power generation device which is configured to generate the electric power by using renewable energy;
causing at least a part of the electric power generated by the power generation device to reversely flow to an electric power system;
determining a power command value to be supplied to a hydrogen production device based on the electric power generated by the power generation device and the electric power that reversely flows to the electric power system; and
outputting the power command value to the hydrogen production device to produce hydrogen in a state where the electric power that reversely flows to the electric power system continuously occurs.
